(19) United States
(12) Patent Application Publication
(10) Pub. No.: US 2007/0122057 A1
(43) Pub. Date: May 31, 2007

(54) Method of scanning an image using surface coordinate values and device using thereof

(76) Inventors: Young-Chan Moon, Seoul (KR); Yang-Keun Yu, Pacifica, CA (US)

Correspondence Address: HARNESS, DICKEY, & PIERCE, P.L.C, 7700 BONHOMME, STE 400, ST. LOUIS, MO, 63105, US

(21) Appl. No.: 10/583,398

(22) PCT Filed: Dec. 13, 2004
(86) PCT No.: PCT/KR04/03267

§ 371 Date: Oct. 16, 2006

(30) Foreign Application Priority Data
Dec. 16, 2003 (KR) 10-2003-0091750

(51) Int. Cl. G06K 9/36; G06K 9/32

(52) U.S. Cl. 382/284; 382/294

(57) ABSTRACT

A surface coordinate image mapping technology (SCIMT) synthesizing and restoring images by using the coordinate value of the surface of the scanned object and matching image data thereto is disclosed. The coordinate value of the position for a surface having the image data of the scanned object is determined. The image data is matched with the coordinate value of the position for the determined surface and collected. The entire image is synthesized by using the coordinate value matched with the collected image data. By performing image scanning following the above process, the entire image can be restored regardless of the size of the image data of the scanned object even when a small sized scanning device is used. Also, regardless of the scanning direction, the entire image can be easily synthesized and restored freely by a single continuous scan.

### TECHNICAL FIELD

The present invention relates to a method of scanning an image using coordinate values of the surface to be scanned and device using thereof, and more specifically a method of restoring image data by determining an absolute coordinate value or relative coordinate value for a surface which has a document or image, matching the scanned image data with the coordinate value, and synthesizing the image data matched with the coordinate value by using the determined coordinate value in the direction of X and Y axes.

In other words, the present invention relates to a method of scanning an image, capable of scanning images larger than the scanner regardless of its size, by reading the surface coordinate value with a small portable image scanning device, matching the scanned image data with the coordinate value, and synthesizing and/or restoring an image in accordance with the coordinate value, and device using thereof.

According to the present invention, with a small size scanner, document and/or images can be scanned and restored to a same or better quality than that of the conventional scanners regardless of the size of the document and/or image which is to be scanned. The technology synthesizing and/or restoring images by using coordinate values of the surface of a scanned object to match image data with the coordinate values, which is a characteristic technology of the present invention as stated above, is referred to as SCIMT (Surface Coordinate Image Mapping Technology) in the following.

### BACKGROUND ART

Scanners generally employ charge-coupled device (CCD) or contact image sensor (CIS) to read various document and/or images on the surface at a predetermined speed and sequence and sequentially store the scanned data in a memory device so as to obtain an image of one document and/or image. The obtained data is transmitted to a computer through a cable and restored in accordance with the speed and sequence in which the document and/or image data was scanned, and to be displayed on the screen or to be printed out by a printer.

Such scanner is required to move CCD and CIS at a controlled velocity, to detect light reflected from the surface, and to accurately detect voltage generated from CCD and CIS due to the above detection, in order to obtain an accurate picture

Meanwhile, scanners invented conventionally are of various sizes, but are installed within a structure that can move at a controlled velocity because it is important to accurately move a CCD or CIS which are essential elements of the scanner with regard to the document or to accurately move the document with regard to CCD or CIS.

In the conventional general method of scanning images, the image is scanned by fixing the object to be scanned to a fixed scanner and measuring the amount of light being reflected among the amount of light generated from the image sensor.

However, when scanning by using a conventional fixed scanner, images larger than the line width of the scan sensor cannot be scanned.

The method of scanning images using a conventional fixed scanner as above is explained referring to FIG. 1.

FIG. 1 is a drawing showing the conventional method of scanning images.

Referring to FIG. 1, the conventional method of scanning images has a problem in that images must be scanned, for example, sequentially from the top to bottom or from the left to right. That is, it has a problem that when scanning a part of an entire image, it must be scanned \textcircled{1} (from left to right), or \textcircled{2} (from top to bottom). If it is scanned \textcircled{3} (from right to left), or \textcircled{4} (from bottom to top), when the recognized data is an image, it is recognized in a reversed form of the original data, and when recognizing letters, the data must be reversed through a separate program.

Also, the conventional method of scanning images as above has a problem in that the entire image of the document cannot be restored by scanning when the size of the scanner is smaller than the document.

### SUMMARY OF THE INVENTION

The present invention is directed to solve the above stated problems of the conventional method of scanning images. It is an object of the present invention to provide a method of synthesizing and restoring an entire image by determining the coordinate value of the surface of the scanned object and matching the scanned image data with the coordinate value, and a device using thereof.

It is another object of the present invention to accurately synthesize and restore the entire image with a small sized scanner that is much smaller than the size of the image of the scanned object.

It is still another object of the present invention to provide a method of scanning images regardless of the scanning direction, for example, in a random direction or in a zigzag or curved line direction, and a device using thereof.

According to an aspect of the present invention, the present invention provides a method for scanning image using a scanning device, comprising: (a) determining a coordinate value of position for a surface having the image data of a scanned object thereon; (b) collecting the image data by matching the image data with the determined coordinate value of position for the surface; and (c) synthesizing an entire image using the collected image data and the determined coordinate value of the position matched with the collected image data.

Preferably, in step (c) of synthesizing the entire image, information for positional movement of the scanning device in the direction of X and Y axes is further used.

More preferably, the scanning device comprises an image scanning part for performing the function of scanning the image, and a position detecting part for determining the coordinate value of the position for the surface.

More preferably, steps (a) and (c) are performed simultaneously.

More preferably, between step (b) and step (c), the method further comprises: (b1) storing the collected image data matched with the coordinate value of the position for the surface.

According to another aspect of the present invention, the present invention provides a scanning device for scanning image, comprising: an input device for determining a coordinate value of position for a surface having image data of a scanned object thereon and collecting the image data by matching the image data with the determined coordinate value of position for the surface; and an image synthesizing device for synthesizing an entire image using the collected image data and the determined coordinate value of the position matched with the collected image data.

Preferably, information for positional movement of the scanning device in the direction of X and Y axes is further used for synthesizing the image in the image synthesizing device.

More preferably, the input device comprises an image scanning part for performing the function of scanning the image and a position detecting part for determining the coordinate value of the position for the surface.

More preferably, the input device performs the function simultaneously for determining the coordinate value for the position of the surface and collecting the image data.

As stated in the above, according to the present invention, not only documents of ordinary use, but also documents which are much larger can be scanned by a small sized scanner regardless of its size, and thus it can be applied for many uses.

Also, according to the present invention, the original image can be restored or combined by using the coordinate value for the surface of each image, and regardless of the scanning direction, images can be scanned in a random direction or in a zigzag or curved line direction.

Also, according to the present invention, even by a small sized scanner, the entire image can be restored using the coordinate value of the image data, and without scanning images by dividing large images into small pieces, the entire image can be easily synthesized and restored by a single continuous scan.

### BRIEF DESCRIPTION OF THE DRAWINGS

FIG. 1 is a drawing showing the conventional method of scanning images.

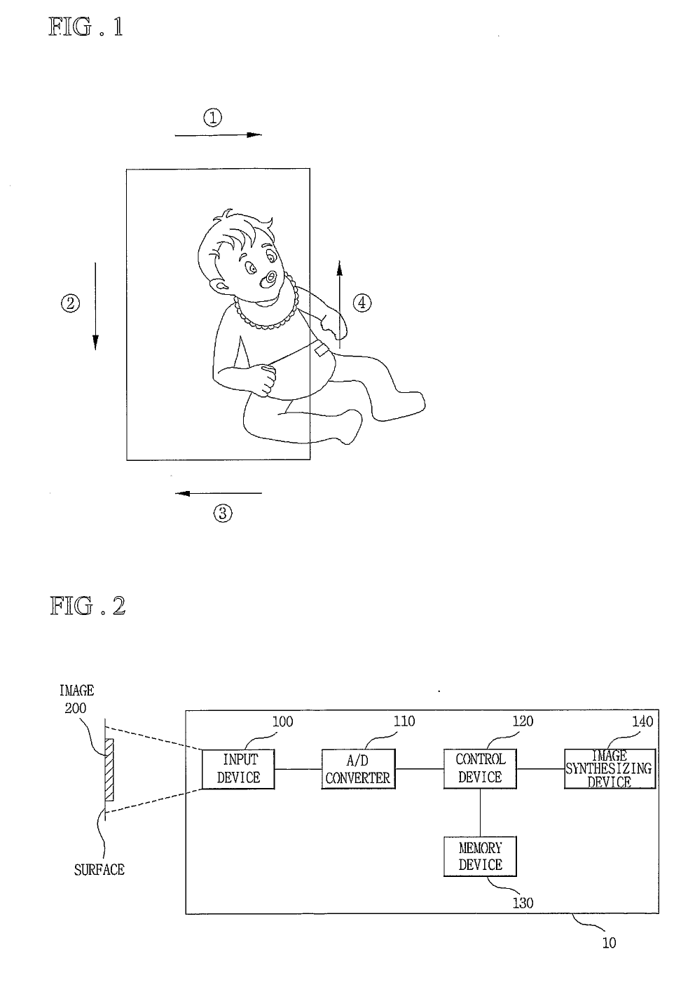

FIG. 2 is a block diagram showing the constitution of the image scanning device according to the present invention.

FIG. 3 is a flow chart showing the process of scanning images according to the present invention.

FIGS. 4a to 4c are drawings showing examples of synthesized image data collected by the image scanning device according to the present invention.

### DETAILED DESCRIPTION

The preferred embodiments of the present invention are explained in detail in the following referring to the drawings attached hereto.

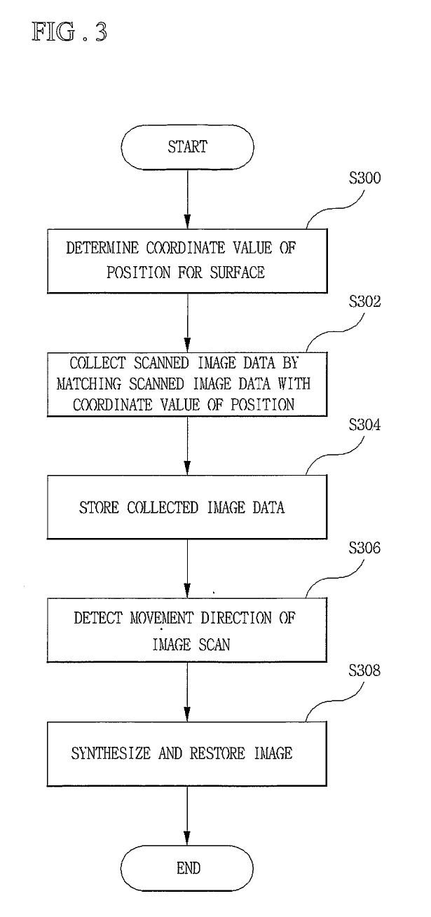

FIG. 2 is a block diagram showing the constitution of the image scanning device according to the present invention.

Referring to FIG. 2, the image scanning device (10) comprises an input device (100), A/D converter (110), control device (120), memory device (130) and image synthesizing device (140).

The input device (100) comprises an image scanning part for performing the function of scanning the image (200) and a position detecting part for detecting the absolute coordinate value or relative coordinate value of the position for the surface by using unevenness, etc. of the surface having the image (not shown).

The image scanning part of the input device (100) is realized as an image input device such as CCD or CIS that detects the light which is emitted from the light source and then reflected against the surface having the image, so as to change the reflected light into voltage, and the position detecting part of the input device (100) detects the absolute coordinate value or relative coordinate value of the surface by using a part of the image scanning part or a separate proper device. Examples of such position detecting part include optical, ball gyro mouse, etc., but it can be easily understood by a person having ordinary skill that it is not restricted thereto. Also, the input device (100) detects the positional movement of the present device (10) in the direction of X and Y axes. This will be explained in detail in the following.

As above, signals generated from the input device (100) are provided to the analogue/digital (A/D converter) (110). The analogue/digital (A/D) converter (110) receives signals inputted from the input device (100) and converts the received signals to digital signals, and then provides the control device (120) with the digital signals.

The control device (120) stores digital signals received from the A/D converter (110) in the memory device (130), and transmits the detected information for positional movement in the direction of X and Y axes and image data matched with the coordinate value of the position for a surface to the image synthesizing device (140) so that they can be properly processed according to the function selected by the user. Also, the control device (120) controls the overall image scanning process between each constitutional element device within the present scanning device (10).

The image synthesizing device (140) synthesizes the image data collected by matching the image data with the coordinate value of the position for a surface. During this synthesizing process, the information for positional movement in the direction of X and Y axes of said detected scan can be used.

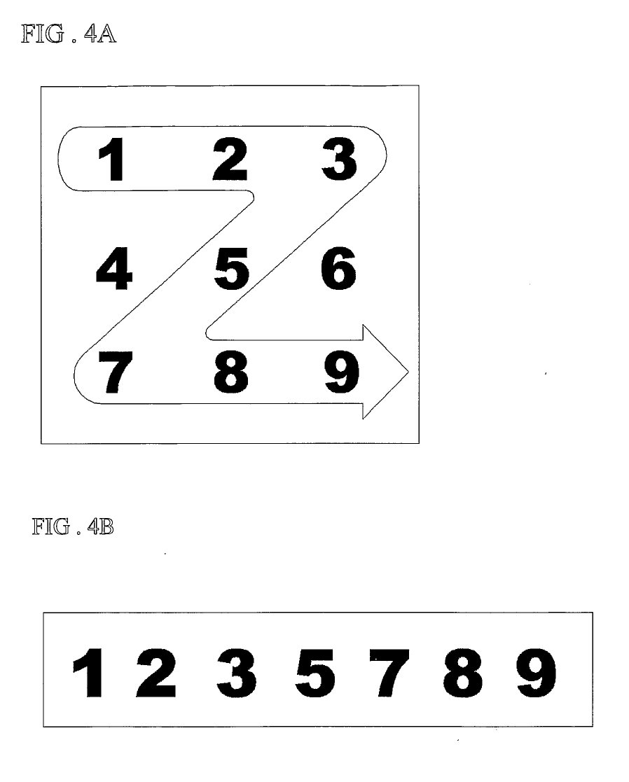

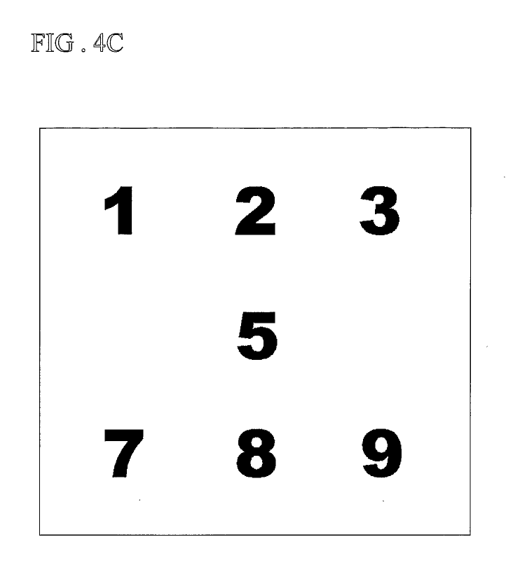

The process of scanning image data according to the present invention is explained in the following referring to FIGS. 3 and 4.

FIG. 3 is a flow chart showing the process of scanning images according to the present invention.

First, spot data of the surface having the image is sequentially read through the position detecting part of the input device (100) to determine the coordinate value of the surface (S300).

Then, the image data read by scanning through the image scanning part of the input device (100) is matched with the coordinate value of the position for the determined surface and collected (S302). In FIG. 3, the step of determining the coordinate value of the surface and the step of collecting image data are expressed as separate steps for the convenience in explaining, but it is obvious that these two steps are performed simultaneously in real time.

Then, the collected image data which are matched with the coordinate value of the position of the surface is stored at the prebuffer (S304).

Then, the movement direction of the image sensor is detected by comparing the coordinate value of the collected data with the image data matched with the coordinate value (S308).

As stated above, in order to scan the surface by the scanning device (10) according to the present invention, it is essential to detect the positional movement of the scanning device (10) in the direction of X and Y axes. This is because a problem that the left and right of the image data can be reversed may be generated when the scanning device moved to the left, but the processing device recognized that the scanning device moved to the right and processed data accordingly. Also, the same problem can be generated when the top and bottom is not distinguished.

Thereafter, the image scanning process according to the present invention is completed by connecting the stored image data with the matched coordinate value data, and synthesizing and restoring the partly scanned image data to its original entire image according to each coordinate value by using the information for positional movement of the detected scanning device in the direction of X and Y axes.

FIGS. 4a to 4c are drawings showing examples of synthesized image data collected by the image scanning device according to the present invention.

In general, paper, plastic plates, etc. which contain data such as letter or image, etc. not only include main data on their surface but also include various spots. The present invention uses the SCIMT for determining the coordinate value of the surface by using the spot present on the surface detected when performing line scanning.

As shown in FIG. 4a, when the scanning device reads a certain area in a certain direction, the scanning device detects the image (1, 2, 3 . . . 9) on the surface of the area and the spot generated on the surface simultaneously, and matches the coordinate values of the position for the detected surface with each image data of the position corresponding thereto and stores the image data.

If the scan of the scanning device is performed along the path shown in FIG. 4a, the image data stored at the prebuffer is stored as image data for each part in the sequence of 1, 2, 3, 5, 7, 8, 9 as shown in FIG. 4b.

However, as stated above, since the image data of each part is stored together with the coordinate value of the position for the corresponding surface, the entire image can be synthesized and restored at the image synthesizing device by using the coordinate value information matched with each partial image data. Accordingly, as shown in FIG. 4c, the image data scanned in FIG. 4a can be restored by being arranged within the area which originally had the partial image data.

The present invention is specifically shown and disclosed referring to the above embodiments. However, these were only used as examples, and it must be understood that a person having ordinary skill in the art may make various modifications within the scope of the present invention as defined in the attached claims.

1. A method for scanning image using a scanning device, comprising:
(a) determining a coordinate value of position for a surface having the image data of a scanned object thereon;
(b) collecting the image data by matching the image data with the determined coordinate value of position for the surface; and
(c) synthesizing an entire image using the collected image data and the determined coordinate value of the position matched with the collected image data.

2. The method according to claim 1, wherein in step (c) of synthesizing the entire image, information for positional movement of the scanning device in the direction of X and Y axes is further used.

3. The method according to claim 1, wherein the scanning device comprises a image scanning part for performing the function of scanning the image, and a position detecting part for determining the coordinate value of the position for the surface.

4. The method according to claim 1, wherein steps (a) and (b) are performed simultaneously.

5. The method according to claim 1, further comprising:
between the step (b) and the step (c), (b1) storing the collected image data matched with the coordinate value of the position for the surface.

6. A scanning device for scanning image, comprising:
an input device for determining a coordinate value of position for a surface having image data of a scanned object thereon and collecting the image data by matching the image data with the determined coordinate value of position for the surface; and
an image synthesizing device for synthesizing an entire image using the collected image data and the determined coordinate value of the position matched with the collected image data.

7. The scanning device according to claim 6, wherein information for positional movement of the scanning device in the direction of X and Y axes is further used for synthesizing the image in the image synthesizing device.

8. The scanning device according to claim 6, wherein the input device comprises an image scanning part for performing the function of scanning the image and a position detecting part for determining the coordinate value of the position for the surface.

9. The scanning device according to claim 6, wherein the input device performs the function simultaneously for determining the coordinate value for the position of the surface and collecting the image data.
